(19) United States
(12) Patent Application Publication
(10) Pub. No.: US 2016/0254778 A1
(43) Pub. Date: Sep. 1, 2016

(54) SOLAR MODULE AND MANUFACTURING METHOD THEREOF

(71) Applicant: HENGS TECHNOLOGY CO., LTD., Tainan (TW)

(72) Inventor: HENG-SHOU CHOU, Tainan (TW)

(21) Appl. No.: 14/634,433

(22) Filed: Feb. 27, 2015

(51) Int. Cl. H02S 30/10; B23P 19/00

(52) U.S. Cl. CPC H02S 30/10; B23P 19/00

(57) ABSTRACT

A solar module is provided. The solar module includes a plurality of frame elements in a surrounding arrangement and a solar panel. Each of the frame elements includes a support plate, a holding plate connected to an end of the support plate, and an adhesion member disposed on a lateral side of the holding plate away from the support plate. The adhesion members jointly form a first surface. The solar panel includes a translucent surface and a lower surface located at one side away from the translucent surface. The lower surface is joined with the frame elements via the adhesion members, and has an outer periphery substantially equal to an outer periphery of the first surface. The translucent surface is located at a highest horizontal height of the solar module.

### FIELD OF THE INVENTION

The present invention relates to a solar module and a manufacturing method thereof, and particularly, to a solar module having a glass surface on which dust is not easily accumulated in order to prevent a power generating capacity of the solar module from degrading due a shielded surface as well as having a more convenient assembly, and a manufacturing method thereof

### BACKGROUND OF THE INVENTION

With the rising of global environmental awareness in the recent years, how to replace fossil energies that produce greenhouse gases by low pollution green energies is one of the essential environmental tasks. Among these green energies, the solar energy, which does not produce greenhouse gases during power generation and has low costs and simple applications, has been a center of attention. A conventional solar power generating module is generally is multi-plate structure, and is mainly consisted of a solar panel and a frame. Due to fragile materials such as glass and diodes of the solar panel, the frame is usually additionally provided to prevent damages during a transportation process of the solar panel. Further, the frame may be utilized to combine the solar panel to a structure of a building.

Referring to FIG. 1 and FIG. 2, in order to provide preferred sunshine efficiency, a conventional solar module usually has a translucent surface face the sky and is installed at an inclined angle of 45° at a location such as a roof of a building. A frame 700 of the conventional solar module is disposed with a claw-like joining portion 710, through which a solar panel 800 is clamped in the frame 700. With such joining means, after applying the solar module for an extended period, as the solar panel 800 and the frame 700 have a height difference in between, dust 900 is easily accumulated between a glass layer 810 of the solar panel and the joining portion 710. As such, the solar module is shielded, leading to issues of decreased sunshine efficiency as well as a reduced power generating capacity. A user is then required to periodically clean a surface of the glass layer 810 in order to maintain an expected power generating capacity, rendering non-ideal utilization. Further, during the manufacturing process, the solar panel 800 first needs to be clamped and secured, and the frames 700 are then individually adhered from one side of the solar panel 800. That is, not only the manufacturing process is made extremely complicated, and risks of defectives are caused due to non-alignment.

### SUMMARY OF THE INVENTION

It is an objective of the present invention to solve an issue of a reduced power generating capacity of the prior art. In a conventional solar module of the prior art, due to a height difference between a frame and a light receiving surface of a solar panel, dust and sand are easily silted to shield the light receiving surface, causing the above reduced power generating capacity.

To solve the above issue, the present invention provides a solar module. The solar module includes a plurality of frame elements in a surrounding arrangement, and a solar panel. Each of the frame elements includes a support plate, a holding plate connected to an end of the support plate, and an adhesion member disposed at a lateral surface of the holding plate away from the support plate. The adhesion members jointly form a first surface. The solar panel includes a translucent surface, and a lower surface located at one side away from the translucent surface. The lower surface is joined with the frame elements through the adhesion members, and has an outer periphery substantially equal to an outer periphery of the first surface.

It is another objective of the present invention to provide a solar module. The solar module includes a plurality of frame elements in a surrounding arrangement, and a solar panel. Each of the frame elements includes a support plate, a holding plate connected to an end of the support plate, an extension plate connected to one side of the holding plate away from the support plate, and an adhesion member disposed at a lateral surface of the holding plate facing the extension plate. The adhesion members jointly form a first surface. The solar panel includes a translucent surface, and a lower surface located at one side away from the translucent surface. The lower surface is joined with the frame elements through the adhesion members, and has an outer periphery substantially equal to an outer periphery of the first surface.

It is yet another objective of the present invention to provide a manufacturing method of a solar module. The method includes following steps. In step S1, a solar panel is provided. The solar panel includes a translucent surface, and a lower surface located at one side away from the translucent surface. In step S2, a plurality of frame elements assembled in a surrounding manner into an integral are provided. Each of the frame elements is disposed with an adhesion member. The adhesion members jointly form a first surface, which has an outer periphery substantially equal to an outer periphery of the lower surface. In step S3, the solar panel is mounted on a platform, with the translucent facing the platform. In step S4, the first surface and the lower surface are joined to adhere the adhesion members to the lower surface.

Thus, the present invention provides following effects compared to the prior art.

1. In the solar module of the present invention, the translucent light is a leveled surface having a highest overall horizontal height, and dust is not easily accumulated on the translucent light. Therefore, the issue of a reduced power generating capacity of the solar panel due to a light receiving surface shielded by dust silt in the lack of periodical cleaning is eliminated.

2. In the present invention, by joining the solar panel and the frame elements through the adhesion members, an overall structure stability is steadily reinforced. An area of a planar surface of the first surface is at most 9% of an area of the lower surface, and the peel strength between the lower surface and the first surface is at least 5400 Pa. Not only the binding stability between the solar panel and the frame is maintained, but also an overall weight of the solar module is optimized.

### BRIEF DESCRIPTION OF THE DRAWINGS

FIG. 1 is a perspective view of a conventional solar module;

FIG. 2 is a perspective view of a conventional solar panel connected to one side of a frame;

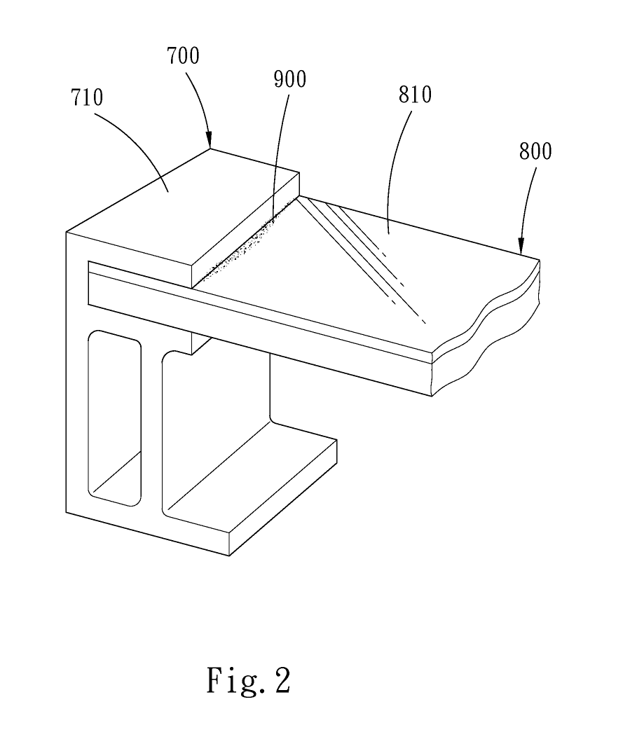

FIG. 3 is an exploded view according to a first embodiment of the present invention;

FIG. 4A is a perspective view according to the first embodiment of the present invention;

FIG. 4B is a section view of FIG. 4A along 4B-4B;

FIG. 5 is an exploded view of a solar panel and one of the frame elements according to the first embodiment of the present invention;

FIG. 6 is a planar schematic diagram according to the first embodiment of the present invention;

FIG. 7 is an exploded view according to a second embodiment of the present invention;

FIG. 8A is a perspective view according to the second embodiment of the present invention;

FIG. 8B is a section view of FIG. 8A along 8B-8B;

FIG. 9 is an exploded view a solar panel and one of the frame elements according to the second embodiment of the present invention;

FIG. 10 is a partial section view according to a third embodiment of the present invention;

FIG. 11 is a schematic diagram of operations of a manufacturing method of the present invention; and

FIG. 12 is a section view of a platform sucked and adhered to a solar panel of the present invention.

### DETAILED DESCRIPTION OF THE PREFERRED EMBODIMENTS

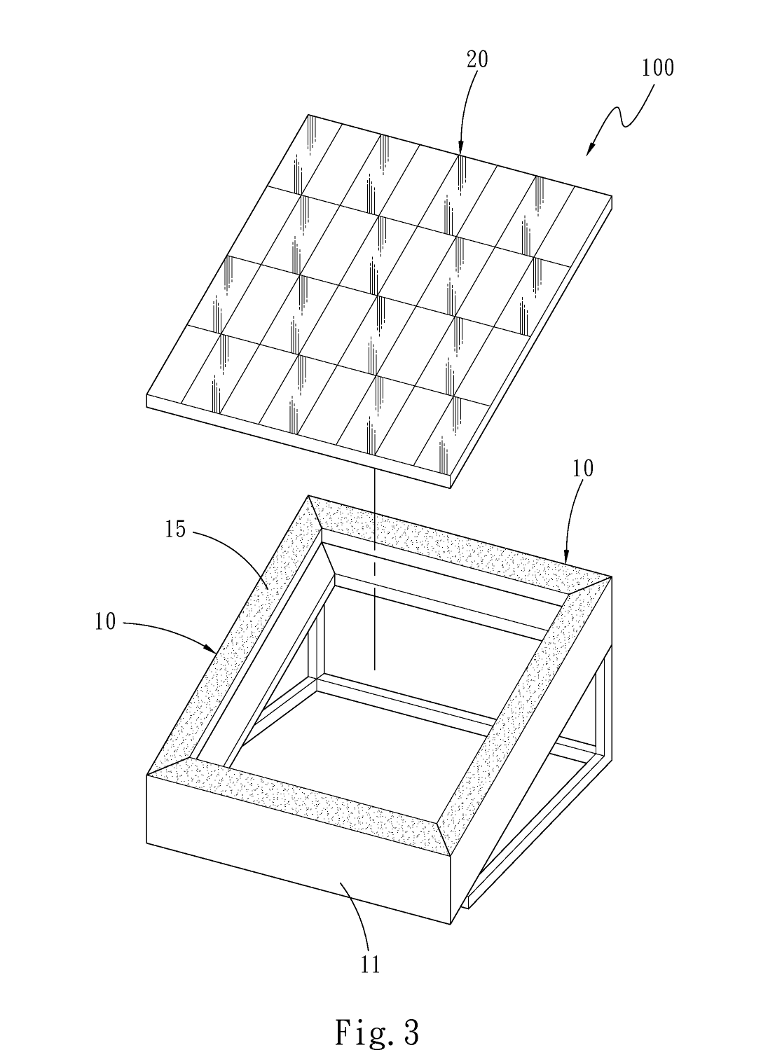

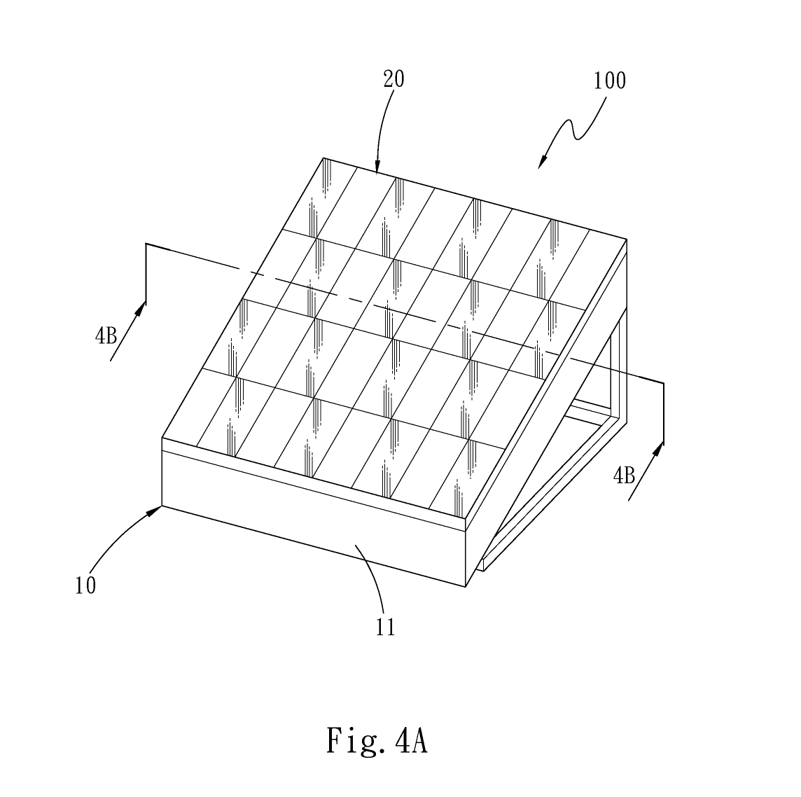

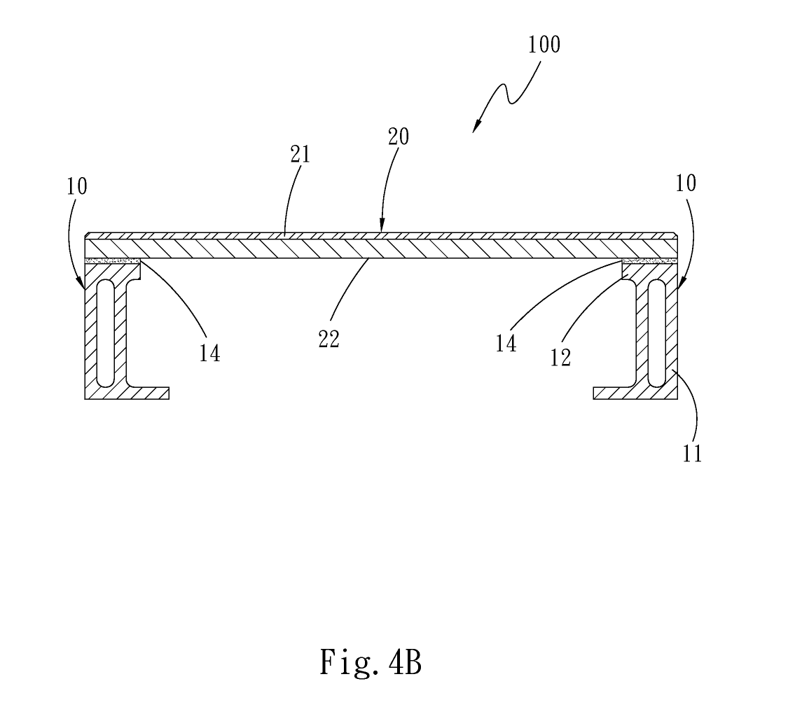

Technical contents of the present invention are described with the accompanying drawings below. Referring to FIG. 3 and FIG. 4A, a solar module 100 provided by the present invention includes a plurality of frame elements 10 in a surrounding arrangement, and a solar panel 20. In the present invention, the term “solar panel 20” refers to a structure that is formed by elements including a glass layer, vinyl ester copolymer (EVA), a finger-like electrode, a PN semiconductor device and a back plate. The structure formed through pressing and heat welding processes provides a function of converting optical energy to electric energy. The solar panel 20 may be assembled and mounted to a rooftop or another structure via the frame elements 10. The structural formation of the solar panel 20 is a generally known technology to one person having ordinary skill in the art, and shall be omitted herein.

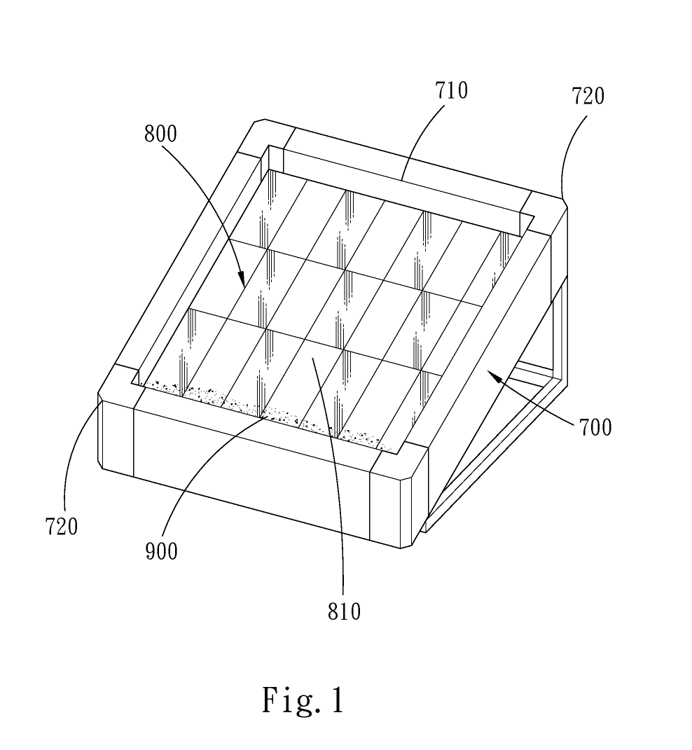

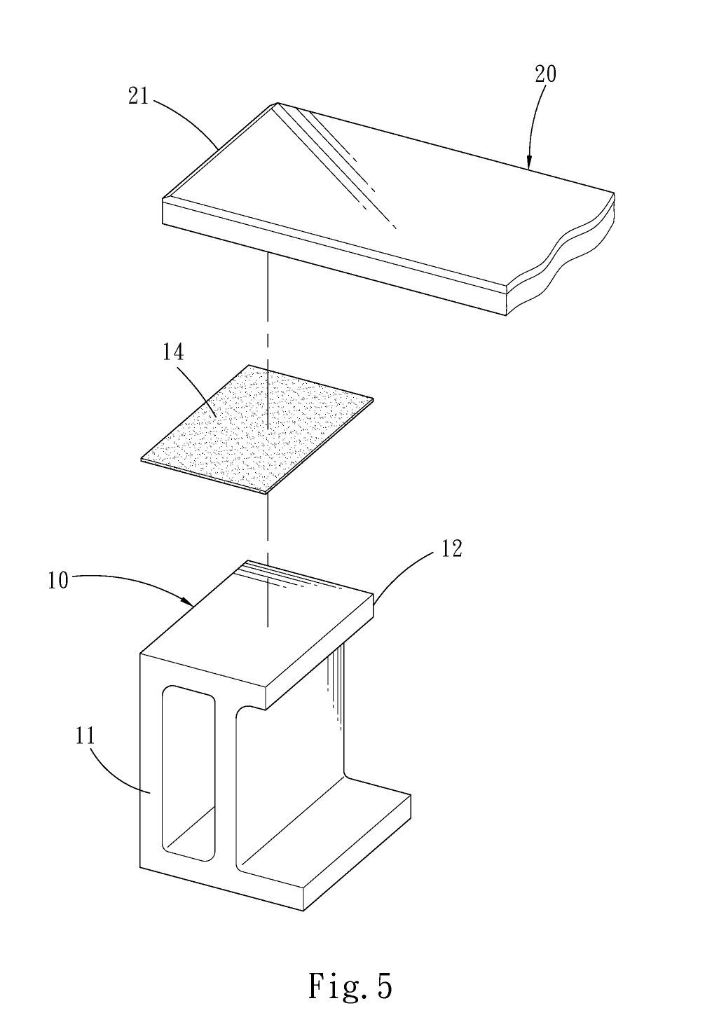

Referring to FIG. 4B and FIG. 5, more specifically, in a first embodiment of the present invention, each of the frame elements 10 includes a support plate 11, a holding plate 12 connected to an end of the support plate 11, and an adhesion member 14 disposed on a lateral side of the holding plate 12 away from the support plate 11. The adhesion members 14 jointly form a first surface 15 (referring to FIG. 3). In the embodiment, the frame elements 10 may be a form a rectangular surrounding configuration. In practice, the frame elements 10 may be assembled to an integral through an element such as an angle box 720 (referring to FIG. 1). The support plates 11 provide a reinforced support capability and a reduced weight, and form a hollow pattern as shown in FIG. 4B.

The solar panel 20 includes a translucent surface 21, and a lower surface 22 located at one side away from the translucent surface 21. The lower surface 22 is joined with the frame elements 10 via the adhesion members 14, and has an outer periphery substantially equal to an outer periphery of the first surface 15.

Further, the translucent surface 21 is located at a highest horizontal height of the solar module 100. In the present invention, the term “translucent surface 21” refers to an outer surface of the solar module 20 that allows light to pass through and irradiate upon a photodiode and converts photoelectric energy to electric energy, and is usually a glass surface.

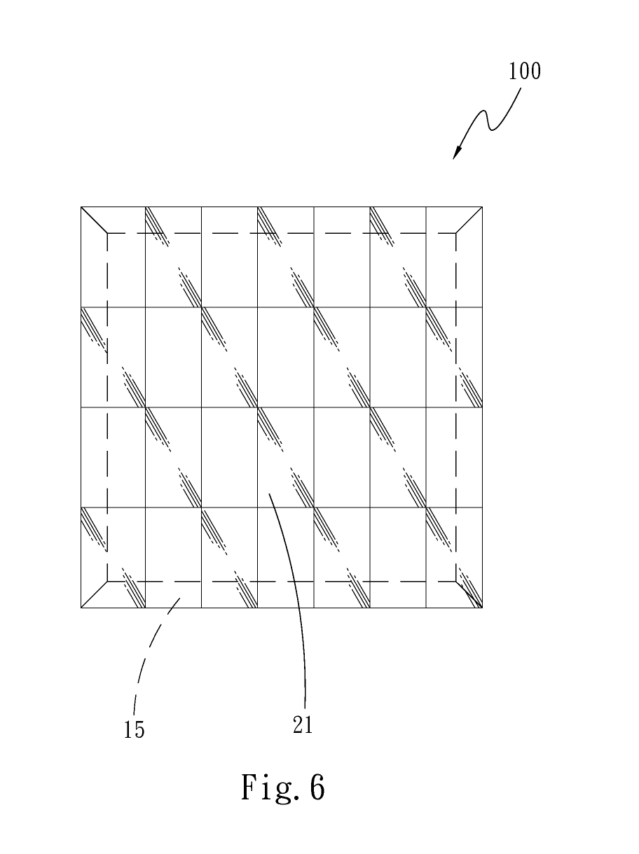

Referring to FIG. 6, a planar area of the first surface 15 is at most 9% of an area of the lower surface 22, and peel strength between the lower surface 22 and the first surface 15 is at least 5400 Pa, so as to provide an appropriate adhesive force and to alleviate stress among the frame elements 10 to obtain preferred balance. The peel strength is strength that assures the lower surface 22 and the first surface 15 are not peeled off from each other when the solar module 100 blows a strong wind having negative/positive pressure strength of 5400 Pa, thereby ensuring the structural stability.

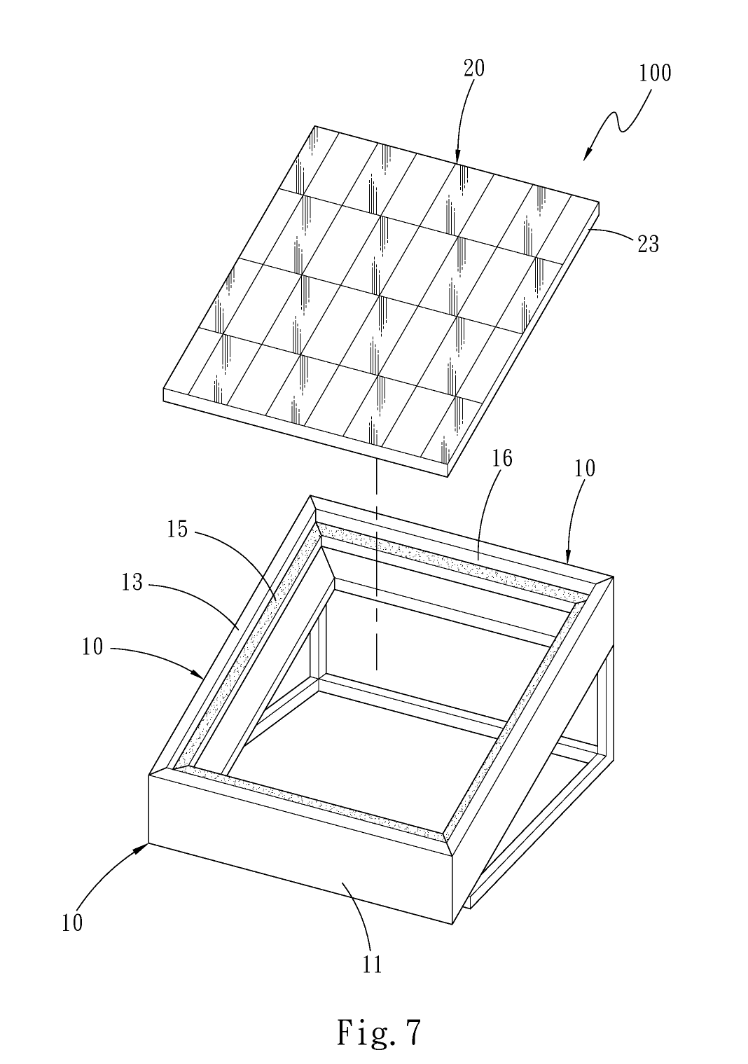

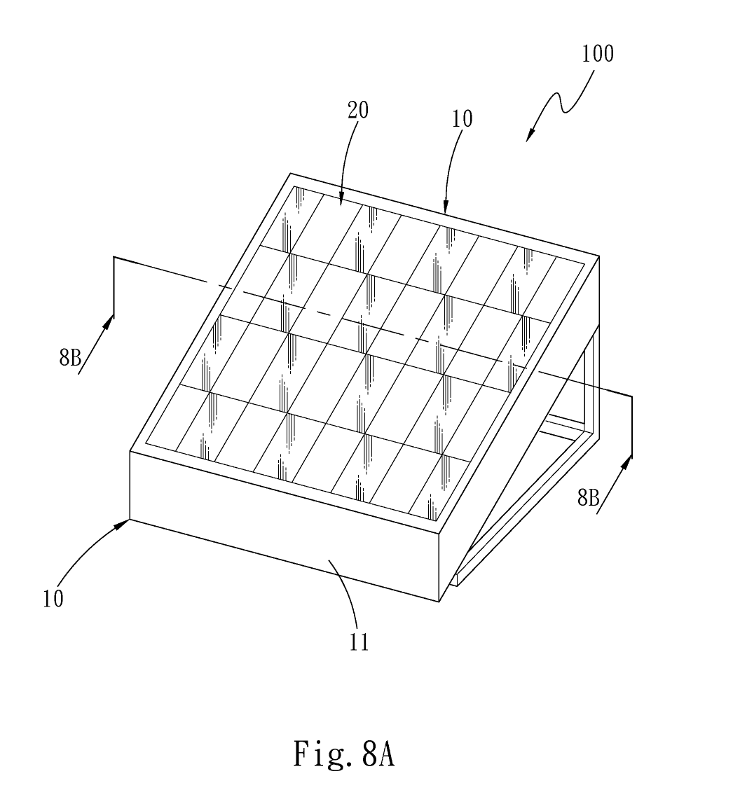

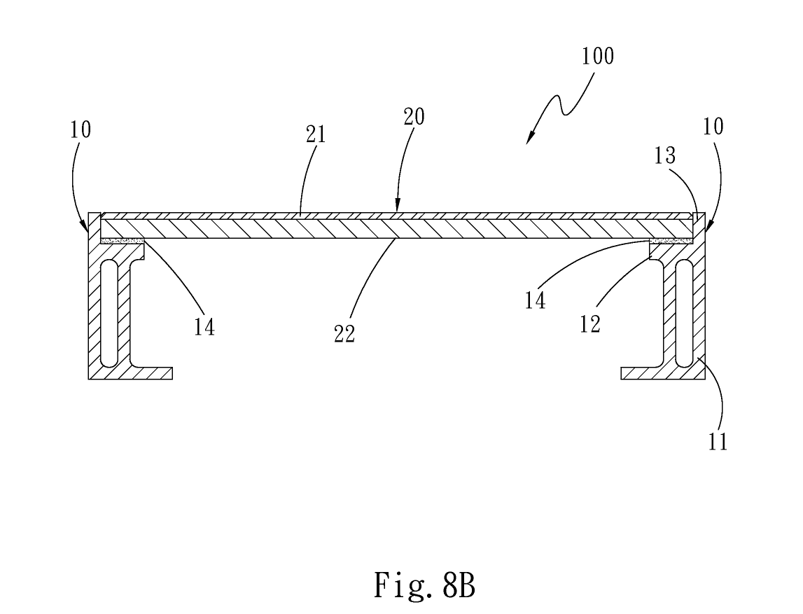

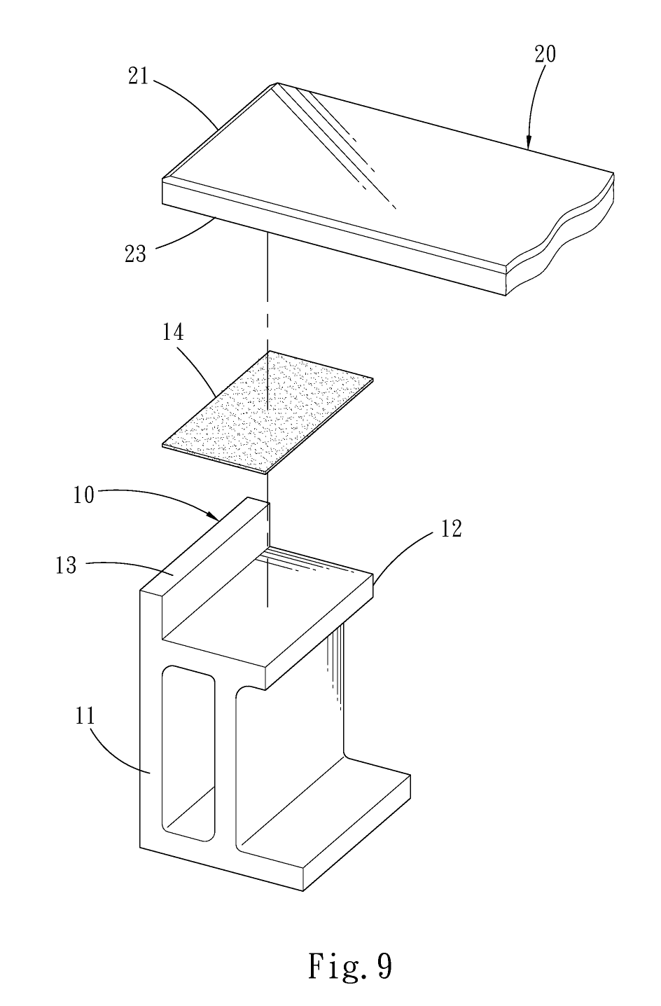

Referring to FIG. 7, FIG. 8A, FIG. 8B and FIG. 9, as the solar panel 20 is a multi-plate structure, to prevent rain water and dust from seeping between the plates in applications over an extended period, the solar module 100 according to a second embodiment of the present invention includes a plurality of frame elements 10 in a surrounding arrangement and a solar panel 20. Each of the frame elements 10 includes a support plate 11, a holding plate 12 connected to an end of the support plate 11, an extension plate 13 connected to one side of the holding plate 12 away from the support plate 11, and an adhesion member 14 disposed on a lateral side of the holding plate 12 facing the extension plate 13. The adhesion members 14 jointly form a first surface 15.

The solar panel 20 includes a translucent surface 21, and a lower surface 22 located at one side away from the translucent surface 21. The lower surface 22 is joined to the frame elements 10 via the adhesion members 14, and has an outer periphery substantially equal to an outer periphery of the first surface 15. Further, the translucent surface 21 is located at a highest horizontal height of the solar module 100. In the embodiment, the extension plate 13 surrounds a periphery of the solar panel 20 to prevent moisture or dust from entering the multi-plate structure of the solar panel 20. As the translucent surface 21 is located at the highest horizontal height of the solar module 100, horizontal heights of top ends of the extension plates 13 are at most equal in height as the translucent plate 21. Further, the extension plates 13 have respective sides facing the support plates 11 jointly form a second surface 16 (as shown in FIG. 7). The solar panel 20 further includes a lateral surface 23 surrounding the periphery of the solar panel 20 and located between the translucent surface 21 and the lower surface 22.

The lateral surface 23 is closely abutted and connected to the second surface 16.

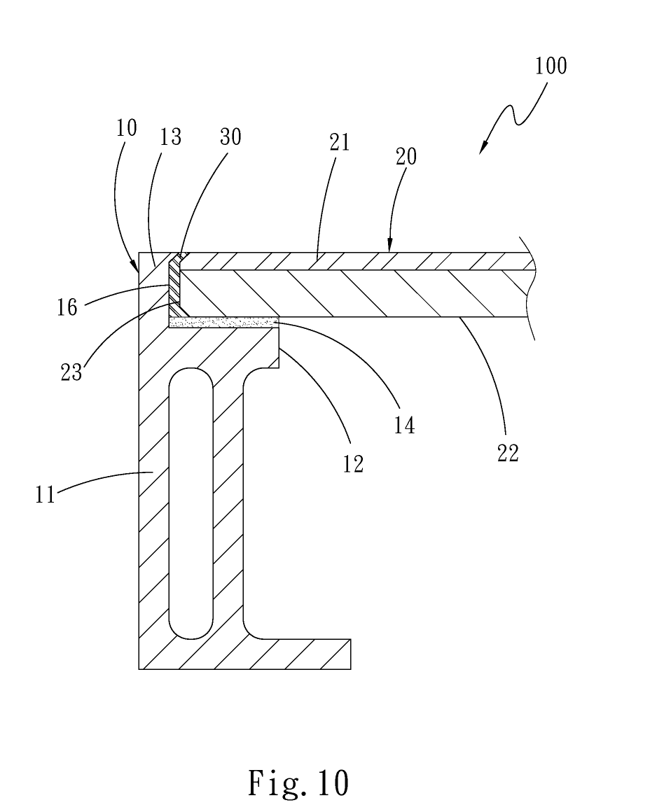

Further, the solar panel 20 includes a protruding portion 24 protruding and extending from the lateral surface 23 towards an outer side. Each of the extension plates 13 includes a recess portion 131 corresponding to the protruding portion 24. For example, the protruding portion 24 may be an arched plane that extends outwards as shown in FIG. 8A. Accordingly, the solar panel 20 may be securely embedded into the recess portions 131 of the extension portions 13 to increase the binding stability. Referring to FIG. 10, as a gap may exist between the solar panel 20 and each of the extension plates 13, the solar module 100 further includes a filler 30, e.g., silicon oxide resin, disposed between the solar panel 20 and each of the extension plates 13. Any excessive filler 30 is scraped off by a scraper, so that top ends of the filler 30, the translucent surface 21 and the extension plates 13 have the same horizontal height.

A manufacturing method of the solar module 100 of the present invention is further given below. In the present invention, examples in FIG. 7, FIG. 8A and FIG. 8B are given for illustration purposes.

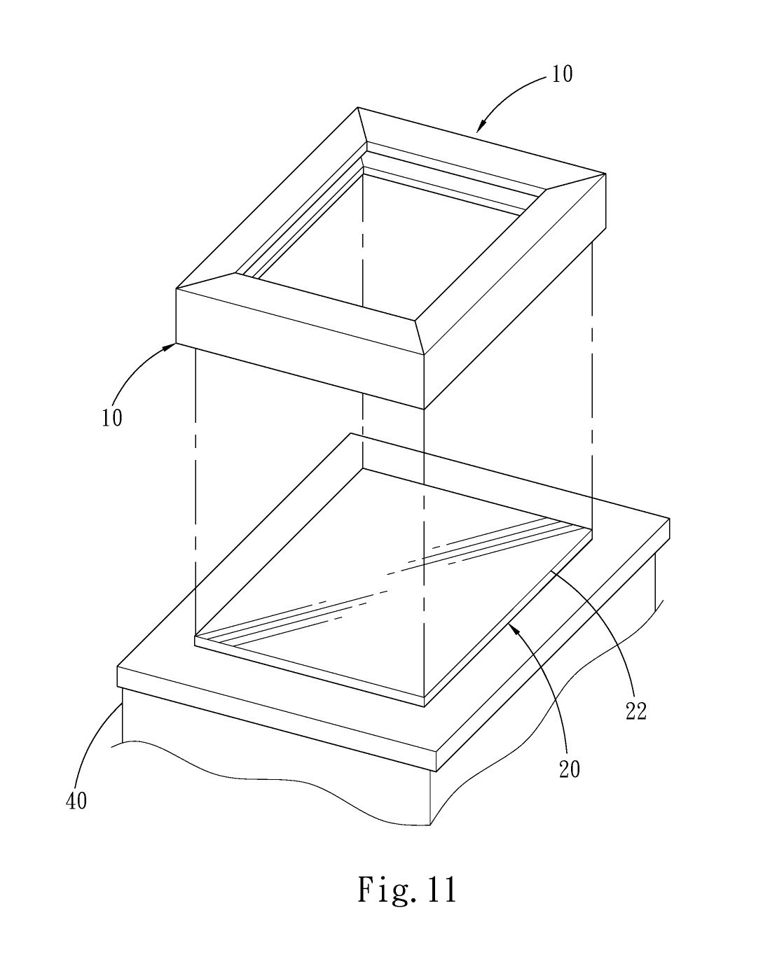

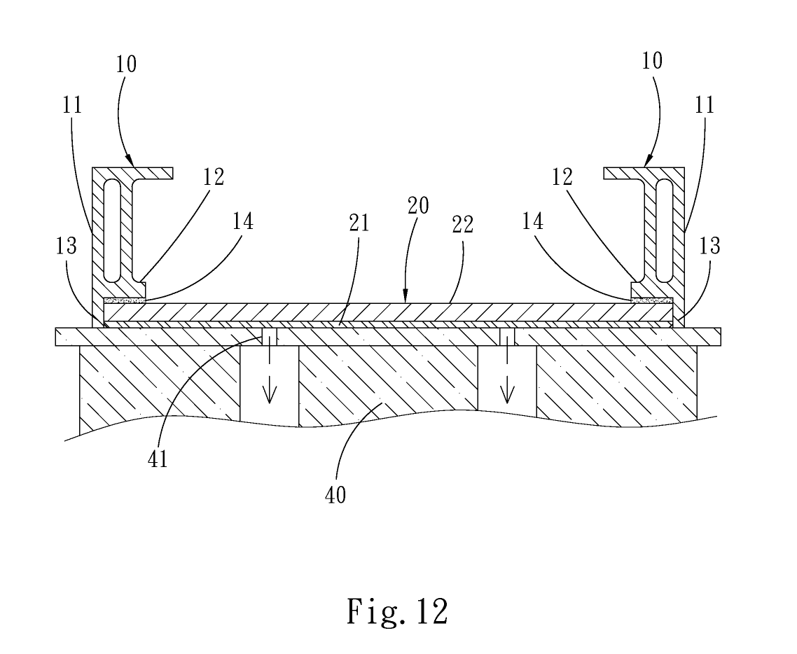

Also referring to FIG. 11 and FIG. 12, the manufacturing method of the present invention includes following steps.

In step S1, a solar panel 20 is provided. The solar panel 20 includes a translucent surface 21, and a lower surface 22 located at one side away from the translucent surface 21.

In step S2, a plurality of frame elements 10 assembled in a surrounding manner into an integral are provided. Each of the frame elements 10 is provided with an adhesion member 14. The adhesion members 14 jointly form a first surface 15, which has an outer periphery substantially equal to an outer periphery of the lower surface 22.

In step S3, the solar panel 20 is mounted on a platform 40, with the translucent surface 21 facing the platform 40. More specifically, the platform 40 may be a suction device, and is provided with a plurality of openings 41 at a joining position with the translucent surface 21. Further, the platform 40 provides a suction force via the openings 41 to secure the solar panel 20.

In step S4, the first surface 15 and the lower surface 22 are joined to adhere the adhesion members 14 to the lower surface 22. In addition, the manufacturing method of the solar module 100 further includes step S5. In step S5, a filler 30 (referring to FIG. 10) is filled to a gap between the solar panel 20 and each of the frame elements 10, and any excessive filler 30 at surfaces of the translucent surface 22 and the frame elements 10 is scraped off after the filling process to enhance waterproof and dustproof effects. Thus, when the solar module 100 of the present invention is assembled and placed up-side-down, the translucent surface 21 is located at a highest horizontal height of the solar module 100. As such, all aligning and positioning operations can be accurately performed at the same time while assembling the frame elements 10, hence achieving effects of being more simple and efficient compared to the prior art.

In conclusion, in the solar module of the present invention, the translucent surface is set to the highest overall horizontal height. When the solar module is installed and mounted at an inclined angle at a location such as a rooftop, dust silt caused by a height difference in the translucent surface and the frame elements can be prevented. Therefore, not only a cleaning frequency can be reduced, but also a failure of achieving an expected power generating capacity due to a shielded translucent surface is eliminated.

What is claimed is:

1. A solar module, comprising:
a plurality of frame elements, disposed in a surrounding arrangement, each of the frame elements comprising a support plate, a holding plate connected to an end of the support plate, and an adhesion member disposed at a lateral side of the holding plate away from the support plate, the adhesion members jointly forming a first surface; and
a solar panel, comprising a translucent surface, and a lower surface located at one side away from the translucent surface, wherein the lower surface is joined with the frame elements via the adhesion members and has an outer periphery substantially equal to an outer periphery of the first surface.

2. The solar module of claim 1, wherein a planar area of the first surface is at most 9% of an area of the lower surface, and peel strength between the lower surface and the first surface is at least 5400 Pa.

3. A solar module, comprising:
a plurality of frame elements, disposed in a surrounding arrangement, each of the frame elements comprising a support plate, a holding plate connected to an end of the support plate, an extension plate connected to one side of the holding plate away from the support plate, and an adhesion member disposed at a lateral side of the holding plate facing the extension plate, the adhesion members jointly forming a first surface; and
a solar panel, comprising a translucent surface, and a lower surface located at one side away from the translucent surface, wherein the lower surface is joined with the frame elements via the adhesion members and has an outer periphery substantially equal to an outer periphery of the first surface.

4. The solar module of claim 3, wherein lateral sides of respective extension plates facing the support plates jointly form a second surface, the solar panel comprising a lateral surface located between the translucent surface and the lower surface, and the lateral surface is closely abutted and connected to the second surface.

5. The solar module of claim 4, wherein the solar panel comprises a protruding portion protruding and extending from the lateral surface towards an outer side, and each of the extension plates comprises a recess portion corresponding to the protruding portion.

6. The solar module of claim 3, further comprising:
a filler, disposed between the solar panel and each of the extension plates;
wherein, top ends of the filler, the translucent surface and the extension plates have a same horizontal height.

7. The solar module of claim 3, wherein a planar area of the first surface is at most 9% of an area of the lower surface, and peel strength between the lower surface and the first surface is at least 5400 Pa.

8. A manufacturing method of a solar module, comprising:
step S1: providing a solar panel, the solar panel comprising a translucent surface and a lower surface located at one side away from the translucent surface;
step S2: providing a plurality of frame elements assembled in a surrounding manner into an integral, each of the frame elements disposed with an adhesion member, the adhesion members jointly forming a first surface, the first surface having an outer periphery substantially equal to an outer periphery of the lower surface;
step S3: mounting the solar panel on a platform, with the translucent surface facing the platform; and
step S4: joining the first surface and the lower surface to adhere the adhesion members to the lower surface.

9. The manufacturing method of a solar module of claim 8, wherein the platform is a suction device and comprises a plurality of openings at a joining position with the translucent surface, and the suction device provides a suction force via the openings to secure the solar panel.

10. The manufacturing method of a solar module of claim 8, further comprising:
step S5: filling a filler to a gap between the solar panel and each of the frame elements, and scraping off excessive filler at surfaces of the translucent surface and the frame elements after the filling process.
